(19) United States
(12) Patent Application Publication
(10) Pub. No.: US 2005/0163899 A1
(43) Pub. Date: Jul. 28, 2005

(54) Multi-compartment packages, particularly for food products

(76) Inventor: Hazel Flores, London (GB)

Correspondence Address: Breiner & Breiner, L.L.C., P.O. Box 19290, Alexandria, VA, 22320-0290, US

(21) Appl. No.: 11/017,118

(22) Filed: Dec. 21, 2004

(30) Foreign Application Priority Data
Jun. 21, 2002 (GB) 0214382.4

(51) Int. Cl. C02F 1/70

(52) U.S. Cl. 426/392

(57) ABSTRACT

Multi-compartment sachets are known, e.g. for vending two or more component snack meals, where the components need to be kept separate until combined when ready for consumption. In accordance with the invention, the exterior of at least one compartment has a cover of heat insulating material, e.g. card, which imparts greater rigidity and body to the compartment forming part of the multi-compartment sachet, and which more particularly acts to stop the user burning his or her fingers if the compartment is, e.g., placed in a microwave oven to heat up its contents.

### FIELD OF THE INVENTION

This invention relates to multi-compartmented packages, particularly, though not exclusively, for use in packaging food products.

### BACKGROUND OF THE INVENTION

In recent decades, food products, particularly snack food products, have been packaged extensively in plastics film sachets. These sachets are inexpensive to produce and easy to manufacture. In particular, manufacturing and filling of the sachet essentially take place simultaneously e.g. by feeding a continuous web of plastics through a filling station at which the sachet is essentially formed around a quantity of product and then sealed. The sealed packages may then be transported e.g. by putting a suitable number of packages into a cardboard box, and putting a number of such boxes on to a pallet for road transport to a desired retail location. At the retailer, the boxes are opened and the packages placed on a display shelf from which they may be purchased individually. The sachet is subsequently opened by the purchaser to enable the contents to be consumed. Tear lines or strips may be associated with the package to facilitate opening, or the package may be simply torn open. To assist tearing the plastics film of which the package is made, a short cut may be provided e.g. in a seal tab or package end, the cut extending from one edge of the package into the plastics film a short distance (but not so far as to break the seal around the contents contained in the package itself).

U.S. Pat. No. 6,254,907 describes flexible packages for holding food or other edible products and having more than one sachet or compartment. A main food-containing sachet is so configured that, when the package is used, it may be opened out essentially to form a bowl containing the food product. This specification also discloses the attachment to such a sachet, of one or more other product containing sachets. Specifically described is a multi-sachet package where the main sachet contains cereal and the other sachets formed integrally therewith, i.e. out of the same film, contain sugar and powdered milk, thus providing the user with a package containing edible cereal which may be converted to a bowl of cereal ready for eating by sprinkling the powdered milk on top of it, optionally sugar if desired by the consumer, and then adding water into the cereal-containing bowl.

A problem which arises with packages of this type is that the bowl is relatively flexible and, once filled with liquid, cannot easily be picked up. A further disadvantage is that if the bowl and its contents are microwaved, e.g. to heat up the contents, the package/bowl may rapidly become too hot to be handled comfortably. The combination of heat and a relatively flimsy structure can lead to accidents, most notably the spillage of hot liquid which is at least messy and possibly additionally injurious to the user.

### OBJECTS OF THE INVENTION

It is a first object of the present invention to provide multi-compartmented package structures which are easier to handle, particularly if filled with liquid. It is a further object of the present invention to provide multi-compartmented package structures which are easier to handle if the contents of the package, particularly a liquid, is hot.

### DESCRIPTION OF THE INVENTION

In accordance with the invention, a multi-compartment sachet is provided over at least a part of its exterior with an outer layer of thermally insulating material. Preferably the outer layer is adhered selectively to the edges of the sachet so as further to enhance the insulative effect between the contents of the sachet and the exterior of the layer which comes into contact with the fingers of the hand if the sachet is grasped.

In one highly preferred form of the invention, the outer thermally insulative layer is attached to the edges of a sachet portion which is configured to be opened out to form a bowl or cup-like container. Such a bowl or cup-like container can be placed in a microwave oven to heat the contents. Because the outer layer is not heated directly by the microwave irradiation (because it contains no or hardly any water), the card remains relatively cool to the touch, and because of the thermal insulating properties of the layer, it can be safely picked up and removed from the oven. Additionally, if the outer layer is relatively rigid compared with the material from which the pocket is made, usually thin plastics film, it acts to strengthen the structure, so that, after heating up in a microwave, the entire container may be safely lifted out without spillage because of the enhanced rigidity of the bowl or cup-like container conferred by the outer layer. The preferred material for the outer layer is card.

The ability to work in this way substantially broadens the range of application of multiple compartment sachets such as described in U.S. Pat. No. 6,254,907.

In a further development of the invention, the outer heat insulating layer is relatively rigid and includes one or more handle portions. For example, a card outer layer may extend laterally of the sachet to one or both sides with the lateral extension(s) preferably being perforated with at least one aperture sufficiently large to insert a finger into. Two such apertures may be provided in the or each extension, one for each of the index and middle finger of a user. An alternative configuration is a slot in the or each extension into which two or three fingers may be inserted.

The sachets may be opened by any conventional means, for example a knife or scissors, but preferably the sachets are provided with one or more short cuts to enable tearing to occur in a controlled fashion. Alternatively to tearing, the package may be provided with one or more tear strips or other known mechanisms to enable it to be opened without difficulty, for example perforated lines of weakness. In all cases, tearing may be assisted by providing in parts of the package one or more apertures into which a finger may be inserted to enable a substantial tearing force to be exerted. This is of particular value for users whose ability to grip a smooth plastics foil is limited, e.g. those suffering from arthritis in the hands and fingers.

### DETAILED DESCRIPTION OF PREFERRED EMBODIMENTS

Preferred embodiments of packages in accordance with the invention will now be described by way of example with reference to the accompanying drawings. In the drawings:

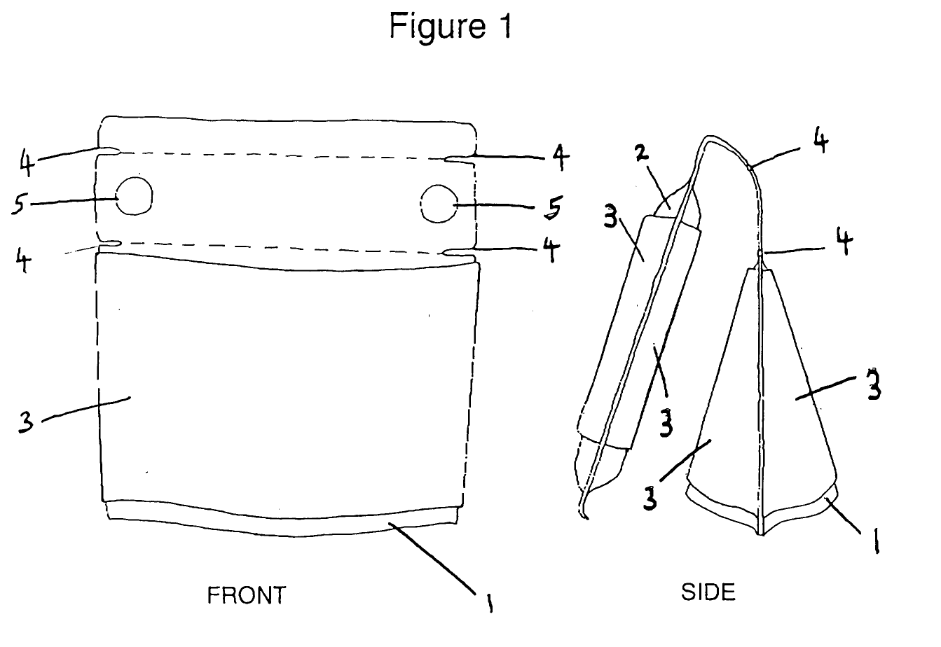

FIG. 1 shows front and side views of a multiple sachet for food packing constructed in accordance with the invention, with the two sachets folded towards one another to produce a package bent in the middle and shown resting with its ends on a surface;

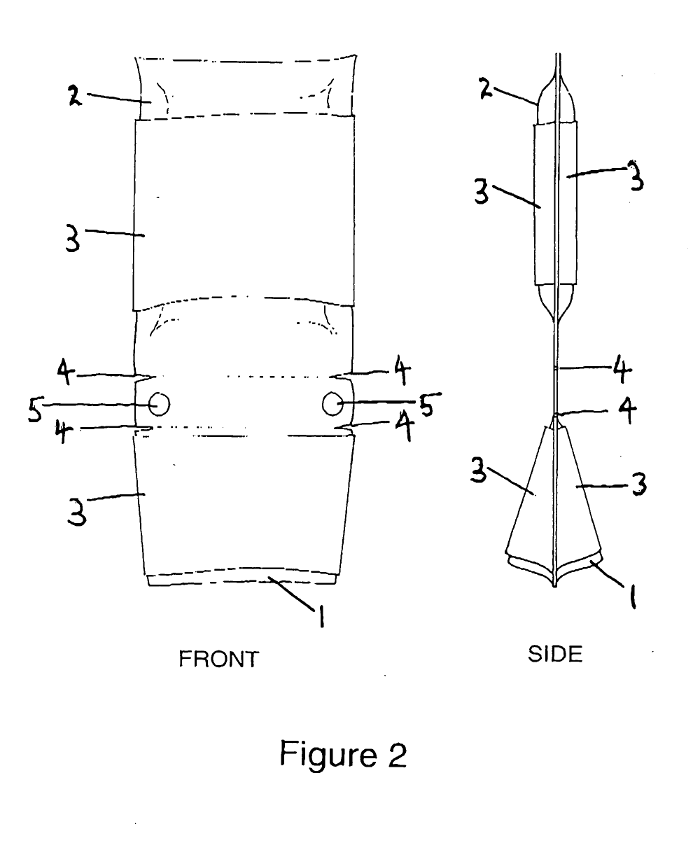

FIG. 2 shows front and side views of the package of FIG. 1 extended;

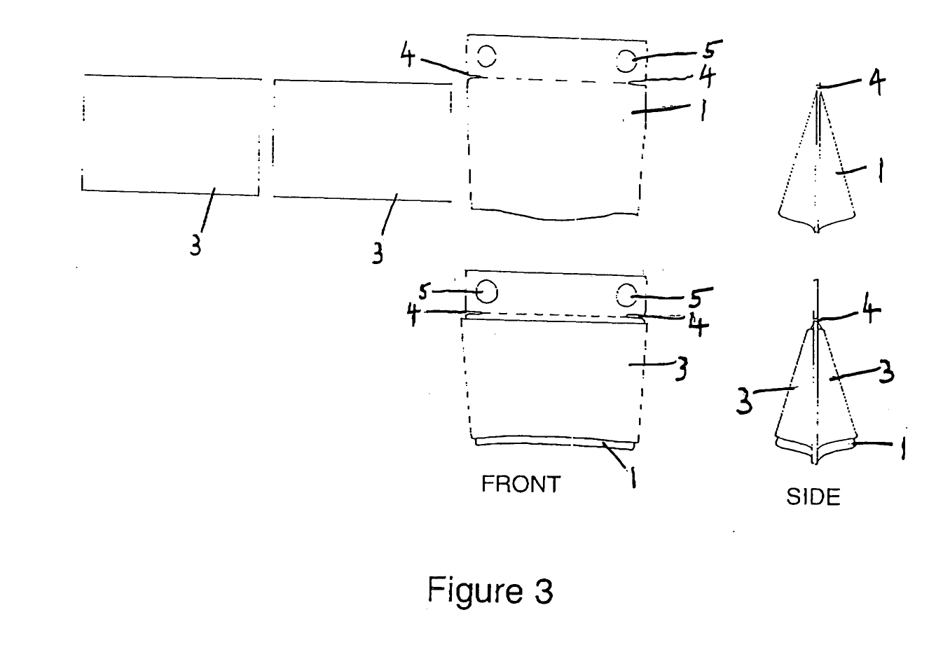

FIG. 3 shows the lower portion of the package as shown in FIGS. 1 and 2 in front and side views as components and as those components are assembled together;

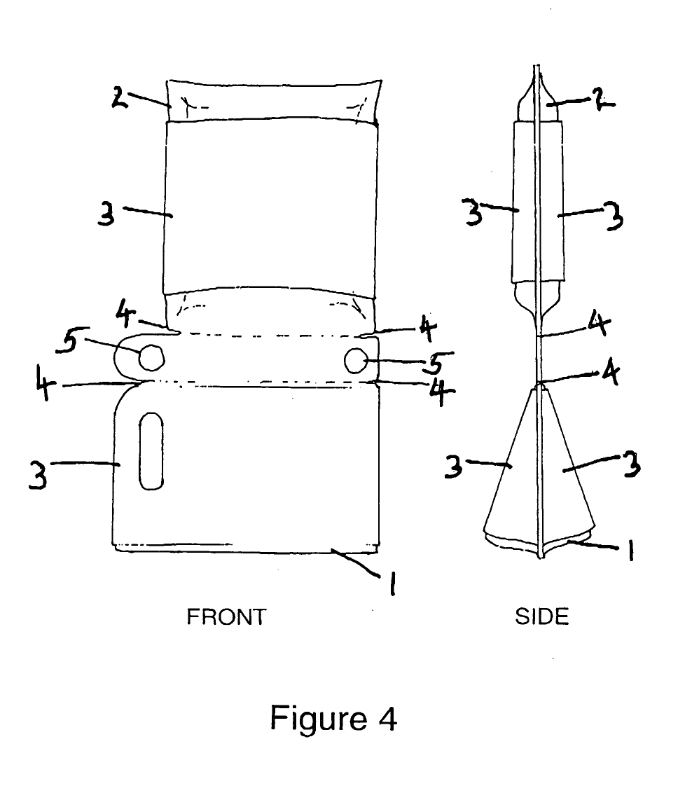

FIG. 4 shows an alternative package construction in front and side views;

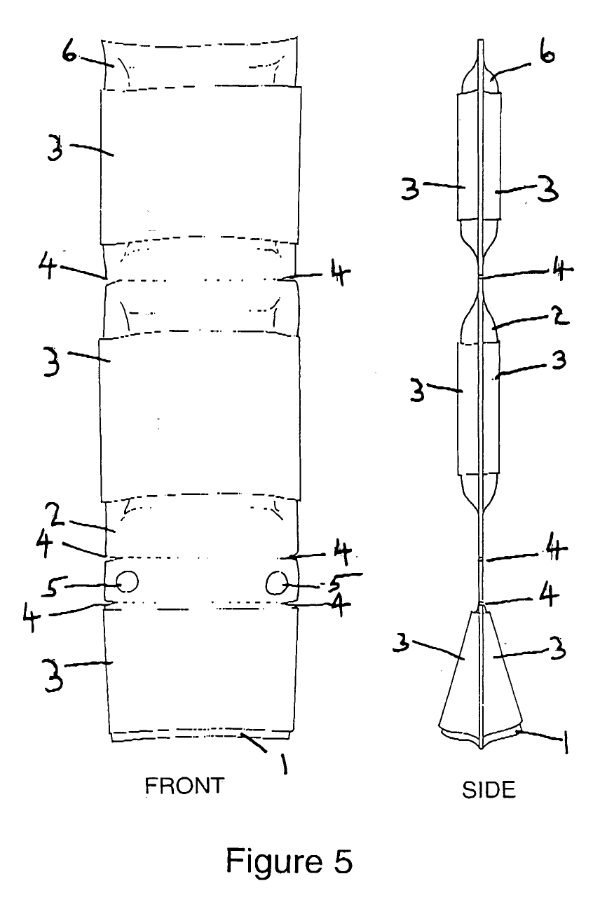

FIG. 5 shows a further alternative construction with three sachets, in front and side views;

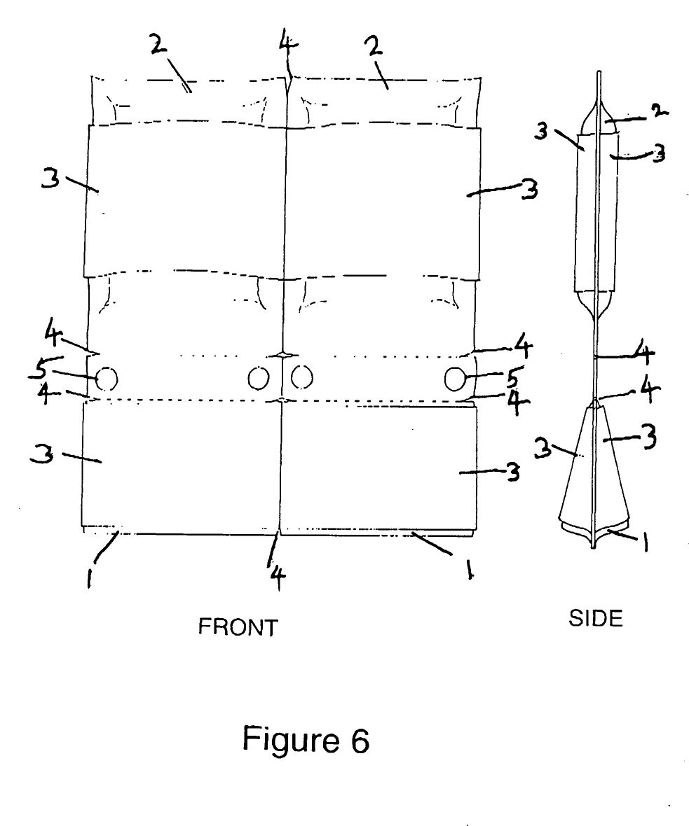

FIG. 6 shows a further alternative construction with four sachets forming a double package in front and side views;

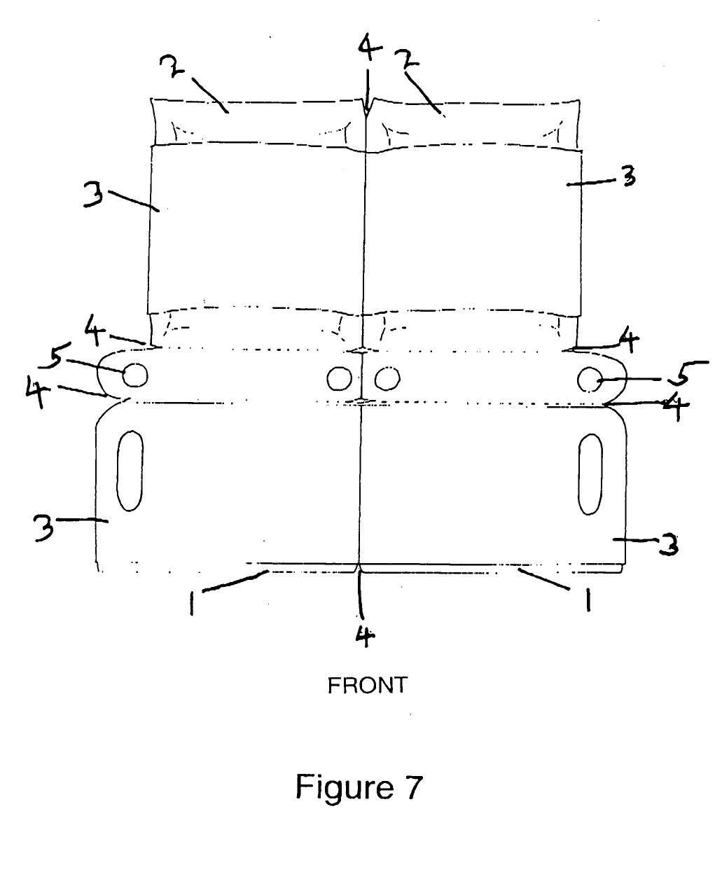

FIG. 7 shows a front view of a further alternative form of double sachet package;

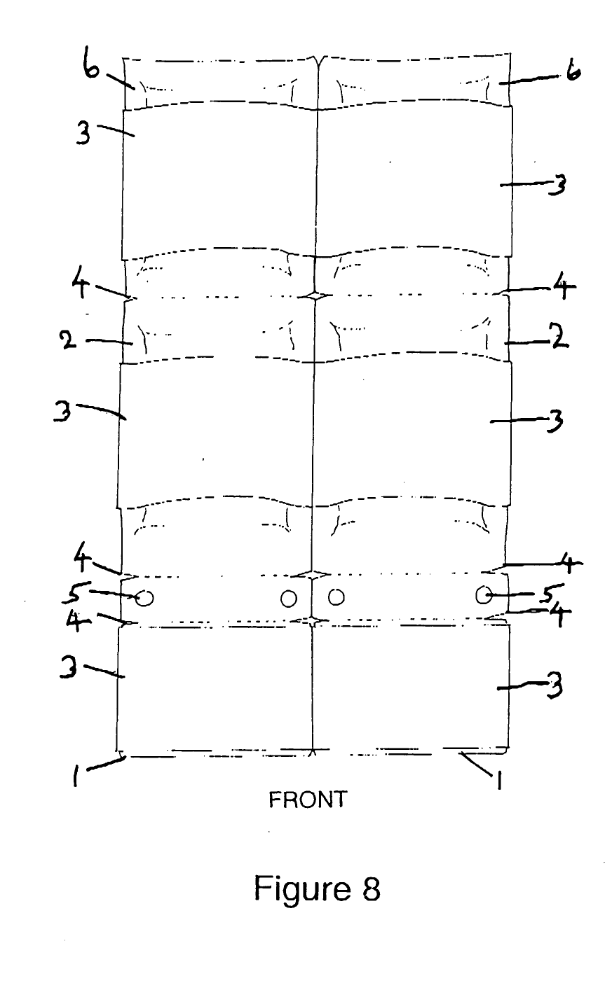

FIG. 8 shows a front view of an alternative construction with six sachets; and

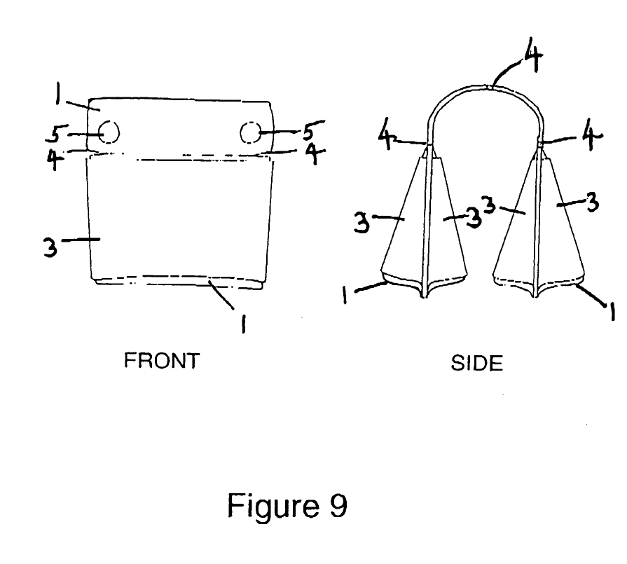

FIG. 9 shows a further embodiment with two sachets, in front and side view.

Throughout the drawings, like reference numerals are used to denote like parts. In the drawings, reference numeral 1, 2 and 6 denote sachets, reference numeral 3 sheets of card, reference numeral 4 cuts to assist tearing, and reference numeral 5 apertures, likewise to assist tearing.

Referring first to FIG. 1, this shows in front and side views a double sachet package according to the present invention. It is basically formed of thin plastics film heat-welded around the product which is to be enclosed to form two sachets 1, 2, which are sealed around the appropriate products. The two film layers between sachets 1 and 2 are held together to form a flexible mid section of the double sachet package allowing it to be folded as shown in the side view in FIG. 1 and thus stood stably on a supermarket or like shelf.

On each side of each of the sachets 1, 2, there are sheets of card 3. These form a thermally insulating barrier around both of the sachets, as well as acting to give the sachets considerably greater structural rigidity. This assists stacking a plurality of such multi sachet packages on display shelves and also assists in protecting the contents from damage if, for example, the contents are friable, for example breakfast cereal products or bakery products, such as dried bread, rusk or biscuit. The side edges of the plastics film are provided with four notches 4, which assist in enabling the two sachets to be torn apart. Tearing will generally occur along the line between the two notches indicated by a dashed line on the drawings, and it may be assisted in following that line, e.g. by perforation or other weakening along that line.

Between each pair of notches 4 at the side is a punched aperture 5. This is of sufficient size for the user to insert a finger into so that either sachet 1 or 2 may be detached from the other sachet by pulling the sachet in one direction with one hand and pulling in the other direction with the other hand having a finger inserted to aperture 5. The sachet itself provides sufficient grip for one hand and the insertion of the finger gives a very firm connection to the toil of the package enabling adequate force to tear the material of the sachets starting at the inner ends of cuts 4.

Generally, before attempting to separate the two sachets, the user will move the two sachets relative to one another so that instead of the shelf display position shown in FIG. 1, they adopt the extended position shown in FIG. 2.

FIG. 3 shows in its upper portion an exploded view in front and side views of the sachet 1 forming part of the sachet container shown in FIGS. 1 and 2 prior to the application of the two cards 3 to either side of sachet 1. They may be applied by any convenient method, for example heat welding along the edges, or using an appropriate adhesive, to form the heat insulated sachet shown in the lower portion of FIG. 3.

The two sachets may be filled with any convenient combination of items or materials. As noted above, the major area of envisaged use for the invention is that of food packaging and, for example, sachet 1 could contain a suitable sauce or the like, while sachet 2 could contain rice, egg noodle or pasta.

The provision of the card layers 3 around sachet 1 means that once that sachet has been detached from the sachet 2 and the remainder of the sachet structure, by cutting or tearing along the dashed line between two cuts 4, it may be capable of being opened out to form a cup or bowl structure which can then be placed in a microwave oven, e.g. to heat the contents in simple fashion.

Once the contents are hot, the presence of the two cards 3 acts to enable the pot sachet to be moved without difficulty.

Movement of the hot sachet 1 may be materially assisted if the cards 3 are extended to form a handle. An approach of this sort is shown in FIG. 4 where, as can be seen from the front view of the double sachet unit there illustrated, the card covers 3 extend to the left of the main sachet portion containing product and an elongate slot has been punched out of the extension through the sachet material and card on either side of it to form a handle into which two or three fingers may be inserted. This enables the container to be picked up even more easily when hot and, for example, the sachet 1 contains soup, even to be used as a makeshift “cup”.

FIG. 5 shows a triple sachet package. The lower two thirds of the package are entirely analogous in construction to the package shown in FIGS. 1 and 2, but there is an additional extra sachet denoted 6 attached to sachet 2 via a plastics-connecting web, i.e. all three sachets 1, 2 and 6 are essentially made of plastics film and constructed together.

FIG. 6 shows a further alterative in which four sachets, two denoted 1 and two denoted 2, are united together in a common double sachet arrangement.

FIG. 7 shows a front view of a four-sachet arrangement with handles formed by lateral extensions of cards 3, while FIG. 8 shows a front view of a doubled-up sachet arrangement which can be thought of as being constituted by two sachets of the type illustrated in FIG. 5 formed side-by-side.

As illustrated in FIG. 1, sachet 1 is of generally pyramidal shape while sachet 2 is generally a flat tablet shape. It is not, of course, necessary to adopt this arrangement, and FIG. 9 illustrates a variety of sachet construction in accordance with the present invention where two similar shaped sachets 1 are shown. Each is heat insulated by way of applied card outers 3. As can be seen from the side view, if these are the sort of generally tapering shape with a base on which they can be set, the resultant double sachet package sits very firmly on a display shelf.

The above description of the varieties of package in accordance with the invention should be taken as illustrative and not limitative. It will be clear to those skilled in the packaging field that numerous variations and other combinations may be made within the spirit and scope of the present invention.

1. In a multi-compartment sachet, the improvement which comprises locating over at least part of the exterior of the multi-compartment sachet, an outer layer of thermally insulating material.

2. A multi-compartment sachet according to claim 1 wherein the outer layer of thermally insulating material is adhered selectively to the edges of the sachet only.

3. A multi-compartment sachet according to claim 1 wherein the outer layer of thermally insulating material is formed of card.

4. A multi-compartment sachet according to claim 1 and including at least one sachet provided with an outer layer of thermally insulating material of a sufficient strength to enable the sachet to be expanded to form a cup or bowl containing the contents of the sachet.

5. A multi-compartment sachet according to claim 1 wherein the outer layer of thermally insulating material extends laterally of at least one of the compartments of the sachet to form a handle.

6. A multi-compartment sachet according to claim 5 wherein the handle includes one or more apertures punched in the lateral extensions of thermally insulating material.

7. A multi-compartment sachet according to claim 5 wherein the outer layer of thermally insulating material extends laterally to both sides of at least one of the compartments to form two handles.

8. A multi-compartment sachet according to claim 1 including at least two compartments and provided with layers of thermally insulating material covering the exterior of at least two of the compartments.

9. A multi-compartment sachet according to claim 8 including three sachets each having a layer of thermally insulating material covering its exterior.

10. A multi-compartment food product-containing sachet consisting of a first compartment enclosing a first food product, a separate compartment separate from said first compartment and enclosing a second food product, at least one of said first arid second compartments having an exterior casing of thermally insulating material applied on the outside of the material forming the compartments.
